(19) United States
(12) Patent Application Publication
(10) Pub. No.: US 2015/0227505 A1
(43) Pub. Date: Aug. 13, 2015

(54) WORD MEANING RELATIONSHIP EXTRACTION DEVICE

(71) Applicant: Yasutsugu Morimoto, Tokyo (JP)

(72) Inventor: Yasutsugu Morimoto, Tokyo (JP)

(73) Assignee: HITACHI, LTD., Tokyo (JP)

(21) Appl. No.: 14/423,142

(22) PCT Filed: Aug. 27, 2012
(86) PCT No.: PCT/JP2012/071535

§ 371 Date: Mar. 6, 2015

(51) Int. Cl. G06F 17/27

(52) U.S. Cl. CPC G06F 17/2785

(57) ABSTRACT

It is an object to highly accurately perform semantic relationship extraction from text data by performing supervised learning of multiple classes using an existing thesaurus as a correct answer. Concerning any pair of words in a text, a plurality of kinds of similarities are calculated and a feature vector including the similarities as elements is generated. A label indicating a classification of a semantic relationship is given to pairs of words on the basis of the thesaurus. Data for semantic relationship identification is learned as an identification problem of multiple classes from the feature vector and the label. Identification of an inter-semantic relationship of two words is performed according to the data for semantic relationship identification.

### TECHNICAL FIELD

The present invention relates to a technique for extracting a semantic relationship between words (hereinafter may be referred to as semantic relationship).

### BACKGROUND ART

According to the spread of personal computers and the Internet, a volume of electronic documents accessible by users is increasing. There is a demand for a technique for efficiently finding a desired document out of such a large volume of document information. In a technique for treating natural languages represented by a document search technique, it is necessary to appropriately treat ambiguity, that is, polysemy and synonymity of languages. The polysemy means that a plurality of meanings are present for the same word. The polysemy causes noise. On the other hand, the synonymity means that a plurality of words having the same meaning are present. The synonymity causes omission. In applications for businesses, in particular, omission, that is, oversight of information often causes a problem. Therefore, it is important to solve the problem of the synonymity.

A synonym dictionary and a thesaurus are language resources for absorbing fluctuation in language expressions in a document and solving the problem of the synonymity and are used in various language processing applications. Since the synonym dictionary and the thesaurus are valuable data, a large number of dictionaries have been manually compiled since long time ago.

Since large costs are necessary for the manual creation of the synonym dictionary and the thesaurus, it has been conventionally attempted to automatically create the synonym dictionary and the thesaurus from text data. As one method for automatically creating the synonym dictionary and the thesaurus, there is a method of focusing on an appearance context of a word, that is, a word and a character string appearing in the vicinity of a word of attention. NPL 1 discloses a context-based synonym extraction technique based on an appearance context. There is also a method for treating, in particular, expression fluctuation in synonyms. NPL 2 discloses a notation-based synonym extraction technique for detecting notation fluctuation of katakana notation. There is also a synonym extraction technique that uses a pattern explicitly indicating a relationship among words such as “C such as A and B”. NPL 3 discloses a pattern-based synonym extraction technique by use of a pattern.

The synonym extraction techniques are based on unsupervised learning, that is, a learning technique of a type for not using manually given correct answers. The unsupervised learning has an advantage that manpower costs are low because it is unnecessary to create correct answers. However, manually created large dictionaries are currently widely usable. It is possible to use the dictionaries as correct answers. The merit of the unsupervised learning is decreasing. On the other hand, in supervised learning, it is possible to obtain high accuracy by using manually created correct answer data.

Under such a situation, NPL 5 discloses a synonym extraction method by the supervised learning. In NPL 5, manually created synonym dictionaries are used as correct answers and synonym extraction is performed by the supervised learning. Specifically, a meaning of a word is represented on the basis of a context of the word explained below, learning is performed by using a synonym dictionary, which is a correct answer, and synonyms are extracted.

The prior arts explained above relate to a synonym extraction technique. In the thesaurus, as semantic relationships other than synonyms, a broader/narrower term relationship, an antonym relationship, a coordinate term relationship, a partitive/collective term relationship, and the like are defined. There is also a technique for extracting relationships other than the synonyms. PTL 1 and NPL 6 disclose a technique for extracting broader/narrower terms according to an existing thesaurus and a context-based inter-word similarity. NPL 4 discloses a technique for extracting a broader/narrower term relationship of words on the basis of an inclusion relationship of words.

These semantic relationships are common in that meanings are similar in all of synonyms, broader/narrower terms, antonyms, and coordinate terms excluding partitive/collective terms. These semantic relationships are collectively referred to as similar terms. When it is attempted to extract a specific kind of semantic relationship in similar terms, a semantic relationship of a classification other than the specific kind of semantic relationship tends to be extracted by mistake. For example, when synonym extraction is performed, broader/narrower terms, antonyms, and coordinate terms are extracted as synonyms by mistake. Therefore, there has been proposed a technique for detailing a classification of a more detailed semantic relationships in such similar terms. NPL 7 discloses a technique for highly accurately extracting synonyms by using a technique for extracting an antonym according to a pattern-based method in the synonym extraction. PTL 1 discloses a technique for distinguishing synonyms and similar terms and dissimilar terms other than the synonyms according to ranking supervised learning.

### CITATION LIST

### Patent Literature

PTL 1: JP-A-2011-118526

### Non Patent Literature

NPL 1: Aizawa, “Study Concerning Similarity Calculation of Words Using a Large Text Corpus”, Information Processing Society of Japan Transaction, vol. 49-3, pp. 1426-1436 (2008).
NPL 2: Kubota, et al., “UniformSystemofKatakanallotation Fluctuation Detection Method for Katakana Notation by Preliminary Classifications and Graph Comparison”, Information Processing Society of Japan Natural Language Processing Study Group Report, NL97-16, pp. 111-117, 1993.
NPL 3: M. Hearst. Automatic acquisition of hyponyms from large text corpora. In Proceedings of the 14th International Conference on Computational Linguistics (COLING-92), pp. 539-545, 1992.
NPL 4: Koyama, Takeuchi, “Hierarchical Systemization based on a Nest Relation of Japanese Compound Word Terms, Information Processing Society of Japan Natural Language Processing Study Group Report”, NL-180, pp. 49-54, 2007
NPL 5: Masato Hagiwara: A Supervised Learning Approach to Automatic Synonym Identification based on Distributional Features, Proc. of ACL 2008 Student Research Workshop, pp. 1-6, 2008.
NPL 6: Matsumoto, Sudo, Nakayama, Hirao: Construction of a Thesaurus from a Plurality of Language Resources, Information Processing Society of Japan Natural Language Processing Study Group Report”, FI42-4, pp. 23-28, 1996.
NPL 7: D. Lin, S. Zhao, L Qin, and M. Zhou: “Identifying synonyms among distributionally similar words”, IJCAI 2003, pp. 1492-1493, 2003.

### SUMMARY OF INVENTION

### Technical Problem

It is an object of the present invention to realize a semantic relationship extraction technique that can distinguish and extract a classification of a detailed semantic relationship in similar terms more highly accurately than in the past. In an approach of unsupervised learning disclosed in Non Patent Literature 7, a manually created thesaurus cannot be used as correct answer data. Therefore, it is difficult to attain high accuracy. On the other hand, in an approach using supervised learning, there is no technique for determining, with any detail, a classification of a plurality of kinds of semantic relationships such as synonyms, broader/narrower terms, antonyms, and coordinate terms.

For example, in a synonym extraction technique disclosed in Non Patent Literature 5, synonym extraction is solved as an identification problem of two values for determining whether words are synonyms. However, a semantic relationship other than the synonyms cannot be extracted. Similar terms other than the synonyms are recognized as dissimilar terms when a classifier correctly operates or recognized as synonyms by mistake.

In a semantic relationship extraction technique disclosed in Patent Literature 1, a problem is treated as a ranking problem to distinguish and treat synonyms and similar terms other than the synonyms. That is, the problem is considered a problem for giving 1 to the synonyms as a rank because the synonyms have extremely high similarity, 2 is given to broader/narrower terms and coordinate terms as a rank because the broader/narrower terms and the coordinate terms have high similarity to a certain degree, although not as high as the similarity of the synonyms, and 3 is given to terms other than the synonyms, the broader/narrower terms, the coordinate terms as a rank because similarity of the terms is low. However, even with the method disclosed in Patent Literature 1, similar terms other than the synonyms cannot be distinguished more in detail like the broader/narrower terms and the coordinate terms.

The present invention has been devised in order to solve the problems explained above and it is an object of the present invention to provide a semantic relationship extraction system that can realize highly accurate processing making use of a thesaurus as a correct answer and, at the same time, extract a plurality of kinds of semantic relationships in detail.

### Solution to Problem

An overview of a representative invention among inventions disclosed in this application is briefly explained below.

The invention is a semantic relationship extraction device characterized by including: means for generating, respectively for a set of words extracted from a text, feature vectors including a different plurality of kinds of similarities as elements; means for referring to a known dictionary and giving labels indicating semantic relationships to the feature vectors; means for learning, on the basis of a plurality of the feature vectors to which the labels are given, as an identification problem of multiple categories, data for semantic relationship identification used for identifying a semantic relationship; and means for identifying a semantic relationship for any set of words on the basis of the learned data for semantic relationship identification.

### Advantageous Effect of Invention

According to the present invention, it is possible to perform highly accurate semantic relationship extraction.

Problems, configurations, and effects other than those explained above are clarified by the following explanation of embodiments.

### BRIEF DESCRIPTION OF THE DRAWINGS

FIG. 1 is a block diagram showing a configuration example of a computing machine system.

FIG. 2 is an explanatory diagram of a processing flow in the computing machine system.

FIG. 3 is an explanatory diagram of a similarity matrix.

FIG. 4 is a conceptual explanatory diagram of similar term extraction by unsupervised learning.

FIG. 5 is a conceptual explanatory diagram of similar term extraction by supervised learning of two values.

FIG. 6 is a conceptual explanatory diagram of similar term extraction by ranking supervised learning.

FIG. 7 is a conceptual explanatory diagram of similar term extraction by supervised learning of multiple classes.

FIG. 8 is a flowchart of semantic relationship extraction processing.

FIG. 9 is an explanatory diagram of a thesaurus.

FIG. 10 is an explanatory diagram of a context matrix.

FIG. 11 is a flowchart of character overlapping degree calculation processing.

FIG. 12 is a flowchart of character similarity calculation processing.

FIG. 13 is an explanatory diagram of a character similarity table.

FIG. 14 is a diagram showing a realization example of a content cloud system in an embodiment of the present invention.

### DESCRIPTION OF EMBODIMENTS

Embodiments of the present invention are explained below with reference to the drawings.

### Embodiment 1

First, a semantic relationship is explained. As the semantic relationship, various semantic relationships are present. As standards for specifying a thesaurus, ISO 2788 “Guideline for the establishment and development of monolingual thesauri” and ANSI/NISO Z39.19-2005 “Guidelines for the Construction, Format, and Management of Monolingual Controlled Vocabularies” are present. In the standards, kinds described below are specified.

(1) Synonyms: a pair of words having the same meaning and interchangeable in a text. “Computer” and “electronic computing machine” and the like.
(2) Broader/narrower terms: A pair of words, one of which is a broader term of the other. “Computer” and “Server” and the like.
(3) Partitive/collective terms: A pair of words, one of which is a part of the other. “Hat” and “brim” and the like.
(4) Antonyms: A pair of words indicating concepts forming a pair. “Man” and “woman” and the like.
(5) Coordinate terms: A pair of words that are not synonymous but have a common broader term. “Router” and “server” and the like.
(6) Related terms: A pair of words that are neither similar nor hierarchical but are conceptually associated. “Cell” and “cytology” and the like.

All of the synonyms, the broader/narrower terms, the antonyms, and the coordinate terms are common in that meanings are similar. Therefore, in this specification, these semantic relationships are collectively referred to as similar terms.

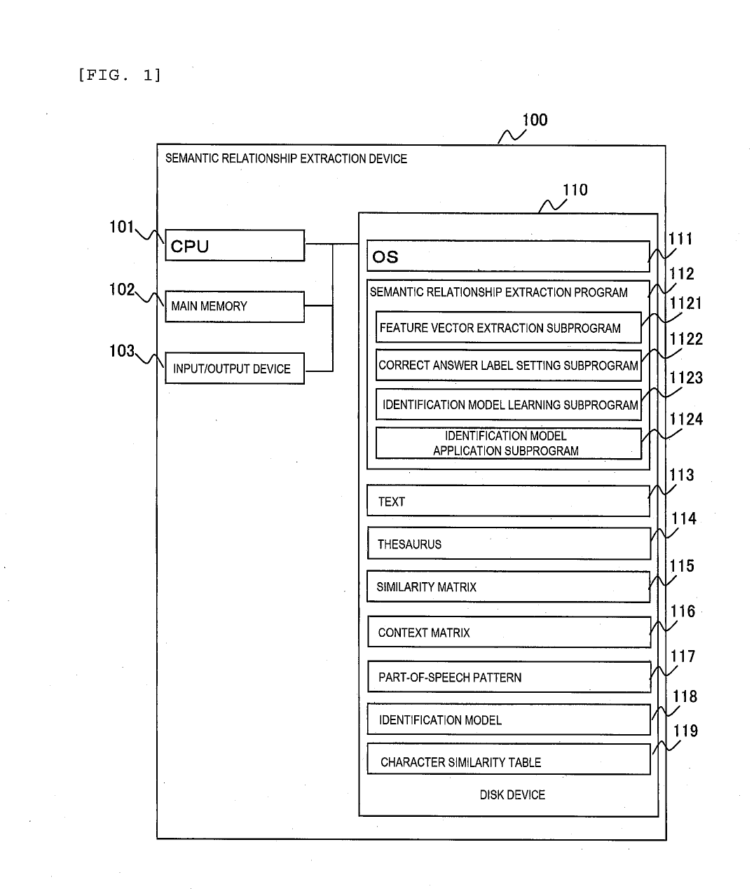

As a first embodiment, a semantic relationship extraction device that simultaneously extracts a plurality of kinds of semantic relationships is explained. FIG. 1 is a block diagram showing a configuration example of a computing machine system that realizes this embodiment. The computing machine system shown in FIG. 1 is used in the first embodiment of the present invention. Note that the computing machine system also includes functions not used depending on an embodiment.

The semantic relationship extraction device 100 includes a CPU 101, a main memory 102, an input/output device 103, and a disk device 110. The CPU 101 performs various kinds of processing by executing a program stored in the main memory 102. Specifically, the CPU 101 invokes a program stored in the disk device 110 onto the main memory 102 and executes the program. The main memory 102 stores the program to be executed by the CPU 101, information required by the CPU 101, and the like. Information is input to the input/output device 103 from a user. The input/output device 103 outputs the information according to an instruction of the CPU 101. For example, the input/output device 103 includes at least one of a keyboard, a mouse, and a display.

The disk device 110 stores various kinds of information. Specifically, the disk device 110 stores an OS 111, a semantic relationship extraction program 112, a text 113, a thesaurus 114, a similarity matrix 115, a context matrix 116, a part-of-speech pattern 117, an identification model 118, and a character similarity table 120.

The OS 111 controls the entire processing of the semantic relationship extraction device 100.

The semantic relationship extraction program 112 is a program for extracting a semantic relationship from the text 113 and the thesaurus 114 and consists of a feature vector extraction subprogram 1121, a correct answer label setting subprogram 1122, an identification model learning subprogram 1123, and an identification model application subprogram 1124.

The text 113 is a text input to the semantic relationship extraction program 112 and does not need to be a specific form. In the case of documents including tags such as an HTML document and an XML document, it is desirable to apply pre-processing for removing the tags. However, processing is possible even in a state in which the tags are included.

The thesaurus 114 is a dictionary in which manually created synonyms, broader/narrower terms, and coordinate terms are stored.

The similarity matrix 115 is a matrix in which a feature vector concerning a pair of words extracted from a text and a synonym dictionary, a label indicating whether words are synonyms, and the like are stored. The context matrix 116 is a matrix in which context information of words necessary for calculating context-based similarity is stored. The identification model 118 is a model for identifying whether a pair of words learned from a similarity matrix is synonyms. The identification model 118 is a model for identifying to which semantic relationship the word pair learned from the similarity matrix belongs. The character similarity table 119 is a table for storing a relationship between characters having similar meanings.

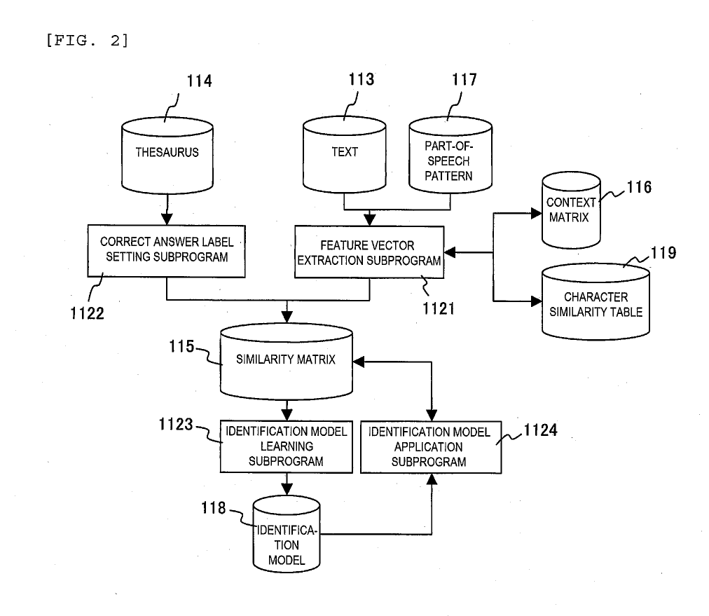

A flow of the processing is as shown in FIG. 2. The feature vector extraction subprogram 1121 reads the text 113, extracts all words in the text, calculates various kinds of similarities with respect to an arbitrary set of words, and outputs the various kinds of similarities as the similarity matrix 115. The context matrix 116, which is information necessary in calculating the similarity, is created beforehand. The part-of-speech pattern 117 is used for creation of the context matrix 116. Note that, in the first embodiment, the correct answer label setting subprogram 1122 reads the thesaurus 114 as correct answer data and sets, in pairs of words in the similarity matrix 115, labels indicating correct answers and classifications of various semantic relationships. The identification model learning subprogram 1123 reads the similarity matrix 115 and learns the identification model 118 for identifying semantic relationship classifications of the pairs of words. The identification model application subprogram 1124 reads the identification model 118 and gives a determination result of a semantic relationship classification to the pairs of words in the similarity matrix 115.

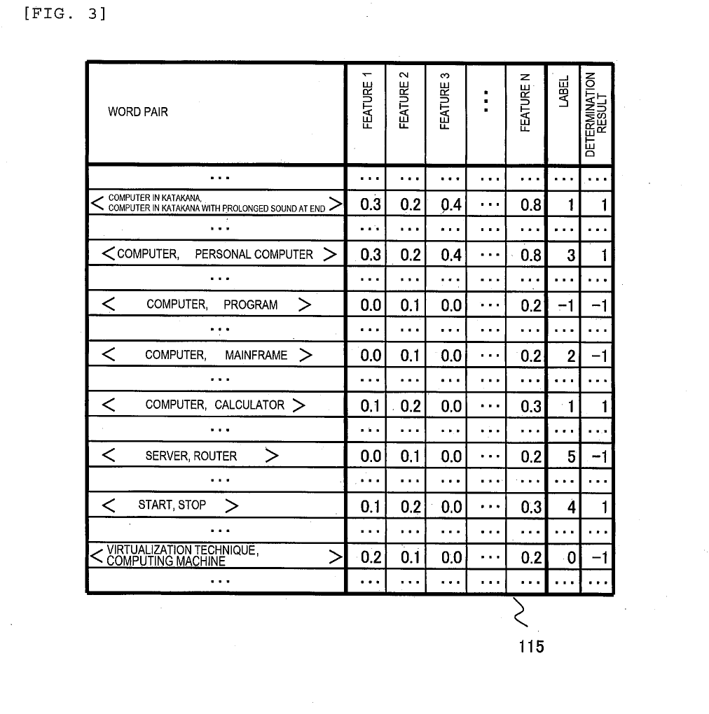

In the following explanation, a basic idea of this embodiment is explained using an example of a similarity matrix shown in FIG. 3.

Any pair of words included in text data is considered. For example, a pair of words is assumed to be <computer, computing machine>. In this case, various scales for determining what kind of semantic relationship the pair of words has can be assumed.

For example, there is a method of using similarity between appearance contexts of words (hereinafter referred to as context-based similarity). Similarity based on notation such as focusing on the number of redundant characters (hereinafter referred to as notation-based similarity) is conceivable. Further, it is also possible to use a pattern called a vocabulary syntax pattern (hereinafter referred to as pattern-based similarity).

Further, in the respective methods, various variations are present. For example, in the context-based similarity, variations are present according to how an appearance context of a word is defined or how a calculation method for a distance is defined. In this embodiment, such various scales are considered to be identities of pairs of words. The pairs of words are represented by feature vectors consisting of a value for each of identities. A configuration method for identities suitable for respective word relationship classifications is explained below. In the example shown in FIG. 3, for example, a pair of words <computer in katakana, computer in katakana with prolonged sound at the end> is represented by a vector in which a value of a dimension of a feature 1 is 0.3, a value of a dimension of a feature 2 is 0.2, and a value of a dimension of a feature N is 0.8. Here, the feature 1 is, for example, a score by context similarity. The feature 2 is a score by notation-based similarity.

After the pairs of words are represented as vectors using scores by various scales as explained above, it is determined using a thesaurus what kinds of semantic relationships the respective pairs of words have and labeling is performed. That is, if <computer, computing machine> are synonyms in the thesaurus, a label equivalent to the synonyms is given to a similarity matrix. If <computer, personal computer> are broader/narrower terms, a label equivalent to the broader/narrower terms is given. If words are not similar terms, a label indicating dissimilar terms is given. Note that, among semantic relationships in similar terms, only broader/narrower terms have a direction and the other semantic relationships do not have a direction. Concerning the relationships not having a direction, it is unnecessary to distinguish pairs of words arranged in different orders, for example, <computer, computing machine> and <computing machine, computer>. Therefore, in the following explanation, in pairs of words, words are arranged in an ascending order of characters and both of the pairs of words are treated as the same pair of words. Concerning the broader/narrower terms, the direction of the relationship is taken into account. When a word on the left side is a broader term, the broader/narrower terms are referred to as broader/narrower terms. When a word on the left side is a narrower term, the broader/narrower terms are referred to as narrower/broader terms. In the example shown in FIG. 3, a label in the case of the synonyms is 1, a label of the narrower/broader terms is 2, a label of the broader/narrower terms is 3, a label of the antonyms is 4, a label of the coordinate terms is 5, a label of the dissimilar terms is −1, and a label of an unknown pair of words is 0.

As explained above, by representing a pair of words as a vector of vales of identities and giving correct answer data to the pair of words, it is possible to solve the pair of words as an identification problem of multiple classes (categories). The identification problem of the multiple classes is a task for identifying to which of three or more classes an unknown case belongs. There is known a method of learning a model of identification according to supervised learning. Semantic relationship classifications such as synonyms, broader/narrower terms, antonyms, and coordinate terms are exclusive. In principle, the semantic relationship, classifications do not belong to a plurality of categories except when words are polysemes. Therefore, by solving the semantic relationship classifications as an identification problem of multiple classes, it is possible to not only distinguish classifications of detailed semantic relationships in similar terms but also improve extraction accuracy of the semantic relationships, for example, synonymous words. The basic idea of this embodiment is as explained above.

In the following explanation, it is explained what kind of scale is effective for each of the semantic relationships.

### (1) Broader/Narrower Terms

### (a) Context-Based System

In a simple context-based system, similarity concerning a certain pair of words is given by a scalar value. When the numerical value is large, the pair of words is considered to be synonyms (in a narrow sense). When the numerical value is equal to or smaller than a medium degree, the pair of words is considered to be similar terms other than the synonyms. Therefore, it is difficult to perform distinction of broader/narrower terms, antonyms, and coordinate terms.

In this embodiment, supervised learning is performed by using asymmetrical scores respectively as identities. If asymmetrical two kinds of scores are used as identities, it is possible to set boundaries to determine, for example, when both the scores are high, the pair of words is synonyms, when one is higher than the other, the pair of words is broader/narrower terms, and, when both the scores are as high as an intermediate degree, the pair of words is coordinate terms.

The asymmetrical similarities refer to similarities at which, when a pair of words is <A, B>, a value for a word B in the case in which the word A is set as a reference and a value for A in the case in which B is set as a reference are different. For example, as a simple example, a case is considered in which the number of common context words is set as similarity for the pair of words <A, B>. In this case, the values are the same irrespective of which of A and B is set as a reference. Therefore, the similarities are symmetrical. On the other hand, asymmetrical similarities can be configured as explained below on the basis of the values. Ranking of similar words is generated with reference to A. It is considered where in the ranking B is ranked. When an inverse of the rank is considered similarity, the values are different when A is set as a reference and when B is set as a reference. For example, broader/narrower terms such as “manufacturer” and “electric appliance manufacturer” are considered, a term such as “trading company” is extracted as a similar term when “manufacturer” is set as a reference. However, the term is not extracted when “electric appliance manufacturer” is set as a reference. In general, a broader term is similar to more kinds of terms. Therefore, a rank of “electric appliance manufacturer” concerning the broader term “manufacturer” is often lower than a rank of “manufacturer” concerning the narrower term “electric appliance manufacturer”. By using such asymmetrical similarities reflecting a difference in distribution of context words, it is possible to determine broader/narrower terms.

### (b) Notation-Based System

In this embodiment, a technique for extracting broader/narrower terms having an inclusion relationship in a word level such as “circuit” and “electronic circuit” is used. A score that is high for a word pair of a composite word and a word serving as a subject of the composite word is used as a feature value. The feature value is not generic because broader/narrower terms of a kind such as “dog” and “animal” cannot be extracted. However, since a large number of broader/narrower terms having inclusion relationships are present as technical terms, the feature value is a strong clue in practical use.

### (c) Pattern-Based System

A pattern-based system is a system most often used for identification of a word pair classification. By contriving a pattern to be extracted, it is possible to extract various word pair classifications. Concerning broader/narrower terms, patterns such as “B such as A” and “B like A” are used.

### (2) Antonyms

### (a) Context-Based System

It is difficult to extract antonyms with a context-based feature value. This is because the antonyms are a pair of words, all attributes of which coincide with each other except certain one attribute, and are extremely similar in context. In this embodiment, a feature value explained below is used as a feature value for extracting a part of antonyms. Among the antonyms, there are a large number antonyms, one of which has a positive meaning and the other of which has a negative meaning, such as “heaven” and “hell” and “good” and “evil”. Therefore, it is determined according to a context whether a word has a positive meaning or a negative meaning. An amount for increasing a score when a pair of words is a set of positive and negative words is considered and used as a feature value indicating whether words are antonyms. As a technique for determining positiveness and negativeness of a word, a publicly-known technique can be adopted. As an example, a negative expression such as “suffer” and a positive expression such as “attain” are extracted using dictionaries of positive terms and negative terms. Positiveness/negativeness (a minus positive degree) of a word is determined on the basis of ratios of these words included in a context. As the antonym feature value, an antonym degree is considered to be higher as a product of positive degrees of a pair of words is larger in minus. Only with the feature value, a pair of a positive word and a negative word, for example, <heaven, evil> is extracted. However, by combining the feature value with other similarity, it is possible to identify antonyms.

### (b) Notation-Based System

Chinese characters are ideograms. Most of antonyms often include antonymous Chinese characters. Since there are not so many kinds of the Chinese characters, it is considered possible to extract an antonymous pair of Chinese characters from antonym data of a correct answer and extract antonyms using the pair of Chinese characters as a clue. However, words are not considered to be antonyms when the words simply include an antonymous pair of Chinese characters. Therefore, a supplementary condition is added. In most of antonyms, characters other than an antonymous pair of Chinese characters coincide with each other as in “rensho” and “renpai”. Even if an antonymous pair of Chinese characters often includes Chinese characters having similar meanings such as “goku” and “koku” in “gokkan” and “kokusho”. Therefore, a feature value is configured according to whether words include an antonymous pair of Chinese characters and include, in common, Chinese characters having the same or similar meanings. The same processing can be applied to a language consisting of phonograms such as English. That is, by considering words in meaningful morpheme units, it is possible to extract morphemes having an antonymous relationship such as “for” and “back” and “pre” and “post”. The notation-based system is not limited to Chinese characters.

### (c) Pattern-Based System

Parallel markers such as hiragana characters ‘ya’ and ‘to’ are patterns used most basically in similar term extraction. Usually, it tends to be considered that synonyms can be extracted. However, actually, antonyms and coordinate terms such as “man and (‘ya’) woman” and “Japan and (‘to’) China” are often derived. On the contrary, the parallel markers are not used in synonyms in a strict sense. For example, notation fluctuations are synonyms in a most strict sense. However, an expression such as “computer in katakana and computer in katakana with prolonged sound at the end” is not usually used. Therefore, a pattern of a parallel expression is introduced as a feature value for antonym and coordinate term extraction.

However, when an extraction result is analyzed, synonyms sometimes appear in parallel. This is because, in a pair of synonyms other than the notation fluctuations, it is rare that ranges meant by the words completely coincide with each other and there is difference between the meanings. Therefore, only with the parallel expression, it is difficult to distinguish word classifications. Therefore, a pattern explained below is concurrently used. When a pattern including antonyms or coordinate terms is analyzed, expressions such as “hell to heaven” often appears. These are expressions indicating that pairs of words before and after the pattern are not synonymous. Such a non-synonymous pattern and the parallel expression are used in combination.

### (3) Coordinate Word

### (a) Context Base

When both of asymmetrical similarities are as high as an intermediate degree, words are considered to be coordinate terms.

### (b) Notation Base

A feature value of extracting only coordinate terms is not particularly added.

### (c) Pattern Base

A pattern same as the pattern of the antonyms is used. A pattern peculiar to the coordinate terms is not used.

### (4) Others

Information concerning whether words are proper nouns is important information, although the information is not a feature value concerning a pair of words. A pair of words such as “Iraq” and “Afghanistan” is extremely similar in context-based similarity. However, in the case of the proper nouns, if the proper nouns do not indicate the same thing, the proper nouns are not considered to be synonyms. Therefore, when both of a pair of words are proper nouns and do not indicate the same thing, it is determined that the two words are not synonyms.

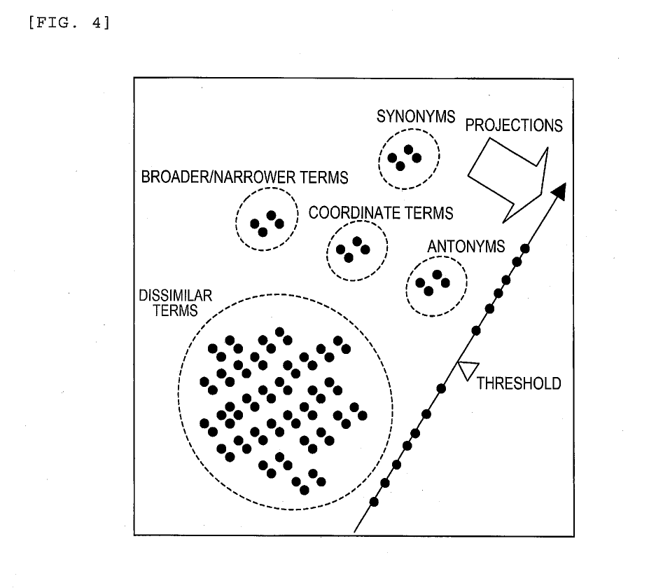

After the pair of words are represented by the feature explained above, a problem is solved as an identification problem of multiple classes. A difference between this embodiment and a conventional technique is explained. In FIG. 4, a conceptual diagram of similar term extraction by unsupervised learning is shown. Feature vectors of pairs of words are equivalent to points on an N-dimensional space represented by identities 1 to N and are represented by black circles in FIG. 4. It is expected that black circles indicating pairs of words belonging to respective word relationships are distributed in close regions in a space. In this case, in the unsupervised learning, scores are calculated according to a function for calculating similarity. This is equivalent to projecting the pairs of words on a one-dimensional straight line. When the pairs of words are projected on the one-dimensional straight line, ranking is defined. Further, by providing a threshold, it is distinguished whether the pairs of words are similar terms. Problems of the unsupervised system are that the projection function (a similarity function) is manually determined and it is difficult to perform correction by a correct answer or the like and that the threshold cannot be automatically determined.

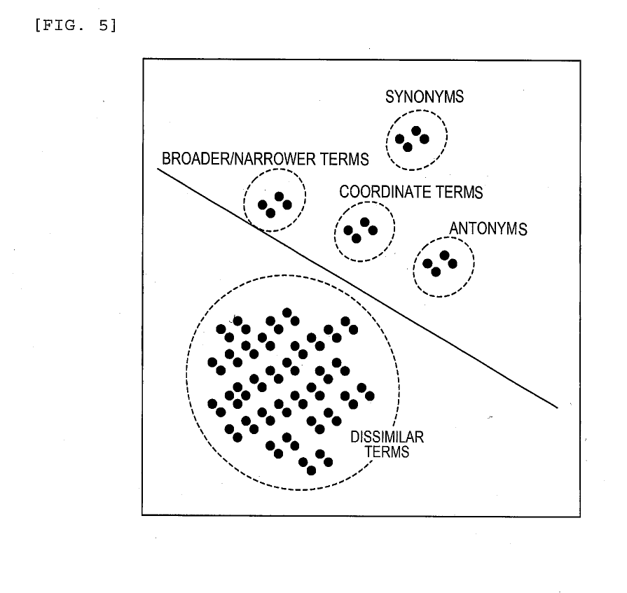

In FIG. 5, a conceptual diagram of similar term extraction by supervised learning of two values is shown. In the supervised learning of two values, a boundary most appropriate for distinguishing two classes is automatically determined according to correct answer data. In this way, the problems due to the unsupervised approach are solved. However, two kinds can only be distinguished. The supervised learning of two values is not suitable for a purpose of distinguishing many kinds of word relationships.

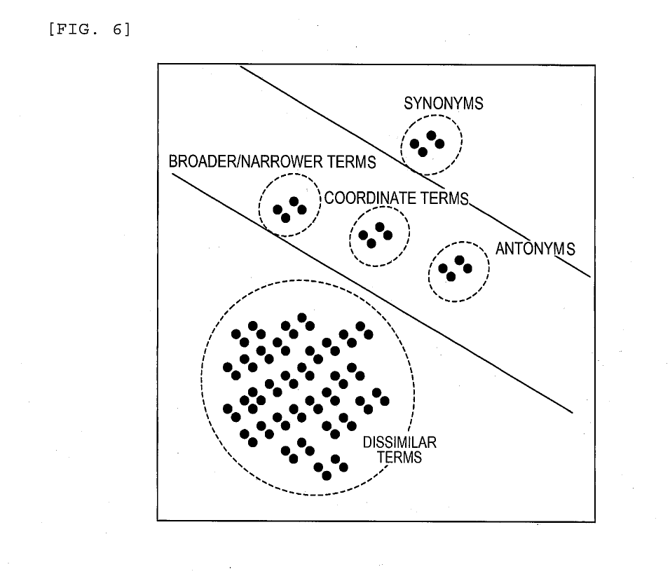

In FIG. 6, a conceptual diagram of similar term extraction by ranking supervised learning is shown. In the ranking learning, unlike the supervised learning of two values, it is possible to treat classification into three or more kinds of classes. The order of cases and, in the case of the similar term extraction, a degree of similarity of a pair of words is learned on the basis of correct answer data. Therefore, it is possible to distinguish synonyms extremely similar to each other, broader/narrower terms similar to each other a little, and dissimilar terms not similar to each other. However, since a one-dimensional value of the degree of similarity is only learned, pairs of words with different kinds of similarities such as broader/narrower terms, coordinate terms, and antonyms cannot be distinguished.

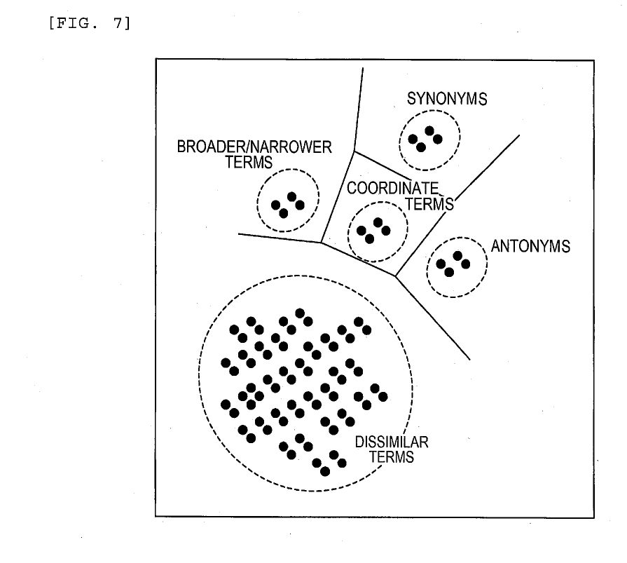

In FIG. 7, a conceptual diagram of similar term extraction by supervised learning of multiple classes in this embodiment is shown. In the similar term extraction by the unsupervised learning of multiple classes, a boundary for setting regions, to which pairs of words of semantic relationships belong, for allocating classes to the semantic relationships is automatically determined. Consequently, since the pairs of words can be distinguished according to a plurality of viewpoints, it is possible to distinguish detailed word pair classifications in similar terms.

Application of an identification model of multiple classes is to determine, when an unknown point, that is, a pair of words, a semantic relationship classification of which is unknown, is given, a semantic relationship according to which region the pair of words belongs.

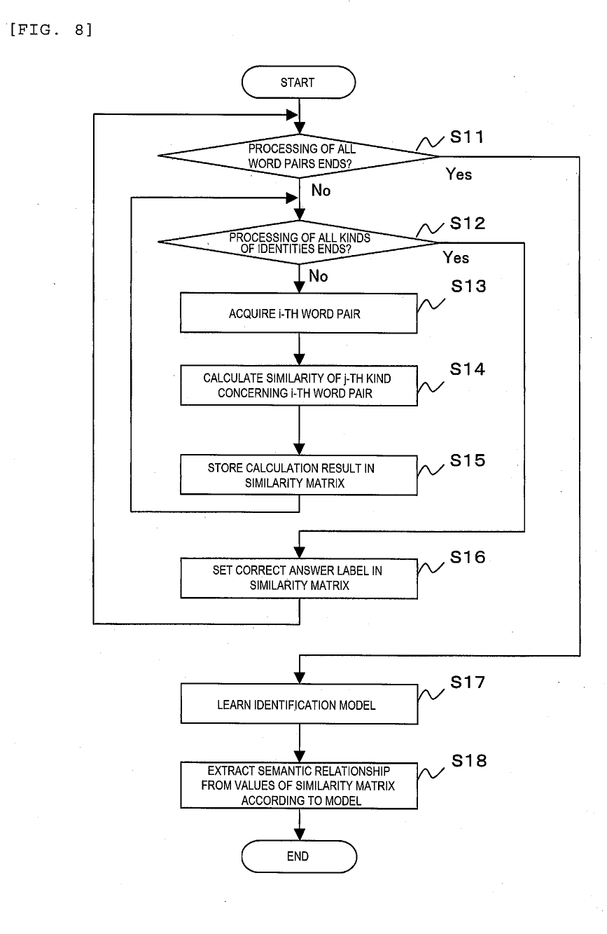

FIG. 8 is a flowchart of semantic relationship extraction processing executed by the semantic relationship extraction device in the first embodiment of the present invention.

In step 11, the semantic relationship extraction device determines whether processing of all pairs of words is ended. If the processing is ended, the semantic relationship extraction device proceeds to step 17. If an unprocessed pair of words is present, the semantic relationship extraction device proceeds to step 12.

In step 12, the semantic relationship extraction device determines whether processing is ended concerning all kinds of identities. If the processing is ended, the semantic relationship extraction device proceeds to step 16. If an unprocessed feature is present, the semantic relationship extraction device proceeds to step 13.

In step 13, the semantic relationship extraction device acquires an i-th pair of words. For the acquisition of a pair of words, for example, a text is subjected to a morphological analysis to create an all-word list in advance. A combination of any two words only has to be acquired out of the all-word list.

In step 14, the semantic relationship extraction device performs calculation of a j-th feature concerning the acquired i-th pair of words. Details of the processing in step 14 will be described later.

Subsequently, the semantic relationship extraction device proceeds to step 15 and stores a calculation result of the feature in a similarity matrix. An example of the similarity matrix is as explained with reference to FIG. 3.

In step 16, the semantic relationship extraction device sets a label in the similarity matrix. The semantic relationship extraction device sets the label by referring to a thesaurus.

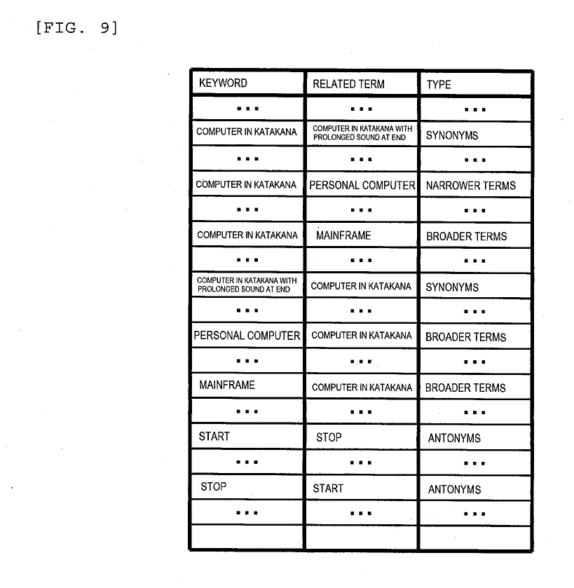

An example of the thesaurus is shown in FIG. 9. The thesaurus is data in which pairs of words and word relationship classifications of the pairs of words are described. In the example shown in FIG. 9, concerning a certain pair of words, one word is stored in a keyword field, the other is stored in a related term field, and a type of the related term with respect to the keyword is stored in a type field. For example, in the case of the example shown in FIG. 9, concerning a pair of words having a broader/narrower term relationship such as <computer, personal computer>, date indicating that “computer” is a keyword, “personal computer” is a related term, and “personal computer” is a “narrower term” (a more specific term) of “computer” is stored. It is assumed that the thesaurus shown in FIG. 9 redundantly retains data for convenience of dictionary consultation. That is, it is assumed that the thesaurus retains, with respect to the pair of words <computer, personal computer>, both of a row in which “computer” is a keyword and a row in which “personal computer” is a keyword. Here, in particular, when a pair of words is in a broader/narrower term relationship, it should be noted that a type of a pair reversed in order is also reversed. For example, “computer” is a broader term of “personal computer”.

In the setting of the label in the similarity matrix, first, the semantic relationship extraction device searches through the keyword field of the thesaurus using one word of a pair of words and further searches for a related term with respect to a row in which the keyword matches to thereby specify a row in which the pair of words matches. Subsequently, the semantic relationship extraction device acquires the type field of the thesaurus and sets the label. However, when the type is a broader term and a narrower term, it is necessary to set a label of a broader/narrower term or a narrower/broader term taking into account a relationship. In the example shown in FIG. 3, the label in the case of the synonyms is 1, the label of the narrower/broader terms is 2, the label of the broader/narrower terms is 3, the label of the antonyms is 4, and the label of the coordinate term is 5. When a pair of words is absent in the thesaurus, the semantic relationship extraction device performs processing as explained below. When a row including a pair of words is absent in the thesaurus but each of the words is included in other rows of the thesaurus, the semantic relationship extraction device gives “−1” as a label of non-synonyms. When at least one word of a set of words is not included in the thesaurus, the semantic relationship extraction device gives “0” as an unknown label.

Referring back to FIG. 8, in step 17, the semantic relationship extraction device learns an identification model. The semantic relationship extraction device leans, from the similarity matrix, an identification model of multiple classes targeting only a row in which a label is not 0. As a learning method for the identification model of multiple classes, any method can be used. For example, a One versus Rest (One-against-the-Rest) method disclosed in J. Weston and C. Watkins. Multi-class support vector machines. Royal Holloway Technical Report CSD-TR-98-04, 1998 is used.

In step 18, the semantic relationship extraction device performs semantic relationship extraction from values of the similarity matrix. The semantic relationship extraction device inputs, concerning all pairs of words in the matrix, feature vectors to a learned classifier and identifies a semantic relationship. The semantic relationship extraction device stores a determination result of the classifier in a determination result field of the similarity matrix.

Consequently, a label equivalent to the semantic relationship is stored with respect to a pair of word, a label of which is “unknown”, that is, The semantic relationship classification result can also be used for a manual error check of the thesaurus. It is possible to efficiently check the thesaurus by extracting, with respect to pairs of words to which labels other than “unknown” are already given, only a pair of words, a label of which is different from a determination result, and manually checking the pair of words.

In the following explanation, the processing in step 14 in FIG. 8 is explained in detail. In step 14, the semantic relationship extraction device calculates various kinds of similarities as identities for representing a pair of words. The similarities are explained below for each of types of the similarities.

### (1) Context-Based Similarity

Context-based similarity is a method of calculating similarity of a pair of words according to similarity of a context of a word. A context of a certain word means a word, a word string, or the like in “the vicinity” of a place where the word appears in a text. Various contexts can be defined according to what is defined as “the vicinity”. As a representative method, in the following explanation, an example is explained in which a verb following a pair of words and an adjective or an adjective verb appearing immediately before the pair of words are used as an appearance context. However, an appearance context other than the appearance context can also be used instead of or in addition or in combination of the appearance context. Various methods are also present as a similarity calculation formal of contexts.

An example explained below, the context-based similarity is calculated on the basis of the context matrix 116. The context matrix consists of a keyword filed and a context information field. Context information consisting of a context word string and repetition of a set of frequencies of the context word string is stored with respect to words in the keyword field.

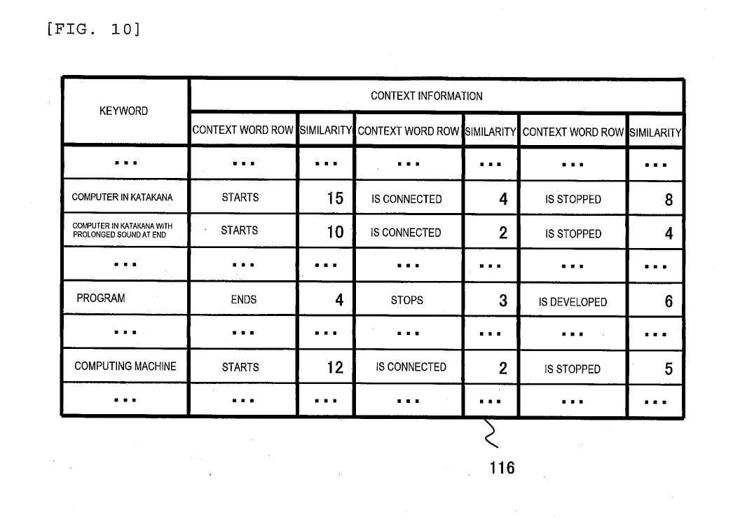

An example of the context matrix is shown in FIG. 10. The example shown in FIG. 10 indicates a case in which a postpositional particle+a predicate following a word of attention is set as a context. For example, the example indicates that “starts” appears fifteen times and “is connected” appears four times in “computer”. Concerning such a context matrix, context information of a row corresponding to any two words is acquired. Similarity is calculated on the basis of a frequency vector of a context word string. As the context-based similarity, a method used for a document search by a term vector model can be used. For example, a method disclosed in Kita, Tsuda, Shishihori “Information Search Algorithm” Kyoritsu Shuppan Co., Ltd. (2002) can be used. In this embodiment, as an example, similarity s is calculated by a similarity calculation method of the following expression:

$$s ( b \vert d ) = \frac{1}{L + κ * [ dlen ( b ) - L ]} * \frac{1}{n} {\sum }_{i} w ( {t}_{i} \vert d ) * v ( {t}_{i} \vert b ) \\ provided that \\ w ( {t}_{i} \vert d ) = log ( 1 + \frac{\# D}{df ( {t}_{i} )} ) * v ( {t}_{i} \vert d ) \\ v ( {t}_{i} \vert d ) = \frac{1 + log ( tf ( {t}_{i} \vert d ) )}{1 + log ( tf ( \cdot \vert d ) )} \qquad [ Math 1 ]$$

d: an input word
ti: an i-th context word string of the input word
b: a target word for which similarity is calculated
#D: a total number of words
df(t): the number of words having the context word string t as a context
tf(t|d): the number of times of appearance of the context word string t in the input word d
tf (•|d): an average of the number of times of appearance of words appearing in the input word d
dlen(b): the number of kinds of context word strings included in the target word b
L: an average of the number of context word string kinds of each word
κ: a constant for normalization of the number of context word string kinds

Here, in general, values of s(b|d) and s(d|b) are different. That is, since the values are asymmetrical, both of s(b|d) and s(d|b) are calculated with respect to a pair of words (b, d) and respectively used as different identities. In this way, in this embodiment, as similarity of a set of words, similarity of context information of two words of the set of words, which is two kinds of similarities including similarity calculated with reference to one of a set of asymmetrical words and similarity calculated with reference to the other, is calculated. That is, by using asymmetrical two kinds of scores as identities, it is possible to set a boundary to determine that, when both the scores are high, the words are synonyms, when one is higher than the other, the words are broader/narrower terms, and when both the scores are as high as an intermediate degree, the words are coordinate words.

Concerning a creation method for a context matrix, it is possible to apply a publicly-known method for, after subjecting a text to a morphological analysis, for example, applying a part-of-speech pattern to a morphological analysis result or performing a syntax analysis.

### (2) Notation-Based Similarity

In the following explanation, a method of calculating notation-based similarity is explained. As the notation base similarity, similarity is calculated on the basis of information concerning characters with respect to a set of words. When synonyms are, in particular, different notation terms such as “computer in katakana” and “computer in katakana with prolonged sound at the end”, as disclosed in Non Patent Literature 2, since many characters overlap, a ratio of the overlapping characters can be used as similarity. The different notation terms are katakana words in principle. However, even in a pair of words consisting of Chinese characters, when meanings are similar, the same characters are often included as in “bunseki in Chinese characters” and “kaiseki in Chinese characters” and “sinrai in Chinese characters” and “sinyou in, Chinese characters”. In the following explanation, similarity based on an overlapping ratio of characters is referred to as character overlapping degree. In the case of a word consisting of Chinese characters, in particular, in the case of a word with a small number of characters such as a two-character word, there are many words having different meanings even if the words includes the same characters such as “bunseki in Chinese characters” and “touseki in Chinese characters”. In this embodiment, the character overlapping degree effectively acts by being combined with a different kind of similarity such as the context-based similarity.

Further, in the case of Chinese characters, there are characters that are different but are similar in meanings. For example, characters such as “shita (u) in Chinese character with hiragana ‘u’ added” and “akoga (reru) in Chinese characters with hiragana ‘reru’ added” have similar meanings. If similarity of such characters can be learned from teacher data, even when the characters do not completely coincide with each other, it is possible to calculate notation-based similarity between words. Similarity of words based on similarity of characters is referred to as similar character overlapping degree.

### (a) Character Overlapping Degree

Overlapping degree of characters can be calculated by various methods. Here, as an example, a method of calculating overlapping degree by counting characters included in common between two words and normalizing the characters with character string length of a shorter word of the two words is explained. When a plurality of the same characters are included, if m characters are included in one word and n characters are included in the other word, a correspondence relationship of m to n is obtained. In such a case, it is assumed that a smaller number of characters of the m and n characters overlap.

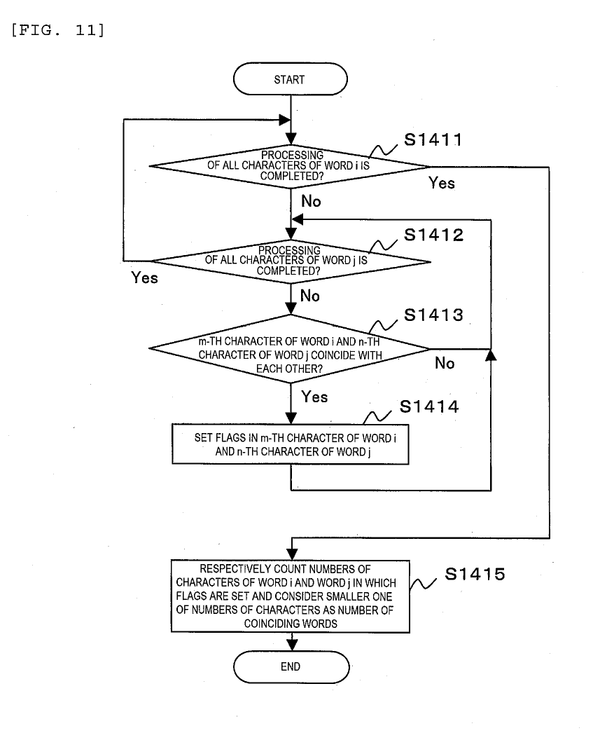

In the following explanation, a calculation method for notation-based similarity of two words i and j is explained with reference to FIG. 11.

In step 1411, the semantic relationship extraction device checks whether all characters of the word i are processed. If all the characters are processed, the semantic relationship extraction device proceeds to step 1415. If an unprocessed character is present, the semantic relationship extraction device proceeds to step 1412. In step 1412, the semantic relationship extraction device checks whether all characters of the word j are processed. If all the characters are processed, the semantic relationship extraction device proceeds to step 1411. If an unprocessed word is present, the semantic relationship extraction device proceeds to step 1413.

In step 1413, the semantic relationship extraction device compares an m-th character of the word i and an n-th character of the word j and checks whether the m-th character and the n-th character coincide with each other. If the m-th character and the n-th character coincide with each other, the semantic relationship extraction device proceeds to step 1414. If the m-th character and the n-th character do not coincide with each other, the semantic relationship extraction device proceeds to step 1412. In step 1414, the semantic relationship extraction device sets flags respectively in the m-th character of the word i and the n-th character of the word j. Thereafter, the semantic relationship extraction device proceeds to step 1412.

In step 1415, the semantic relationship extraction device counts respectively the numbers of flagged characters of the word i and the word j and sets a smaller one of the numbers of characters as a number of coinciding characters. For example, if it is assumed that “window in katakana” and “window in katakana with prolonged sound at the end” are processing targets, three characters of “u”, “n”, “do” are coinciding characters. Since two characters “u” are included in “window in katakana”, flagged characters in “window in katakana” are four characters and flagged characters in “window in katakana with prolonged sound at the end” are three characters. Therefore, three characters are coinciding characters.

Besides the method, variation are conceivable; for example, a common portion character string length from the beginnings of two words is set as overlapping degree, a common portion character string length from the ends of the two words is set as overlapping degree, a character string length to be normalized is set as an average of the common portion character string lengths, and the character string length to be normalized is set as longer one of the common portion character string lengths. As a more precise method, for example, it is possible to collate two words through DP matching or the like and calculate notation-based similarity on the basis of the number of matched characters. It is also possible to calculate a larger number of notation-based similarities according to usable calculation resources. Further, it is also possible to change, on the basis of frequencies of characters, weight at the time when the characters coincide with each other. In a search for a document, an IDF (Inversed Document Frequency) is known as a method of calculating weight of a word. However, if it is considered from the same idea that importance of characters included in common in a larger number of words is small, it is possible to calculate weight of the characters.

### (b) Similar Character Overlapping Degree

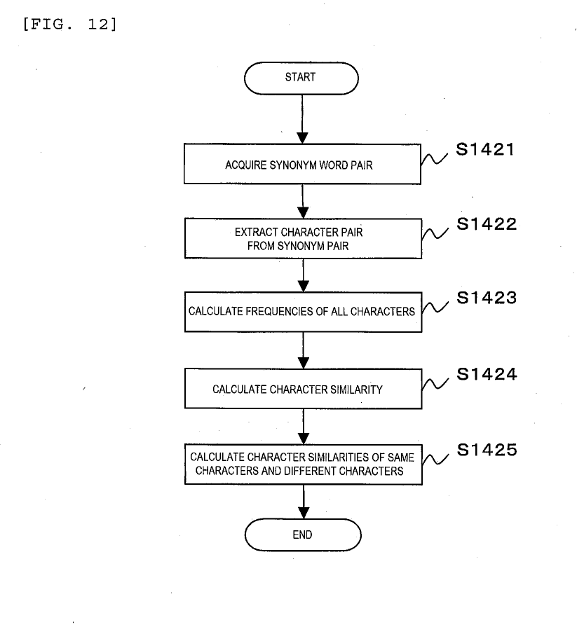

Similarity of characters is learned from a synonym dictionary and overlapping degree of the characters including similar characters is calculated. A calculation method for similarity of characters is explained with reference to a flowchart shown in FIG. 12.

In step 1421, the semantic relationship extraction device acquires a pair of words, which are synonyms, from the synonym dictionary. Subsequently, in step 1422, the semantic relationship extraction device acquires, concerning all combinations, a pair of characters consisting of a character extracted from one word of the pair of words and a character extracted from the other word. For example, when “keibo in Chinese characters” and “doukei in Chinese characters” are a pair of words, which are synonyms, the semantic relationship extraction device acquires four pairs of words “kei in Chinese character”/“dou in Chinese character”, “kei in Chinese character”/“kei in Chinese character”, “bo in Chinese character”/“dou in Chinese character”, and “bo in Chinese character”/“kei in Chinese character”.

Subsequently, the semantic relationship extraction device proceeds to step 1423 and calculates frequencies of characters included in all words in the synonym dictionary. Subsequently, the semantic relationship extraction device proceeds to step 1424 and calculates character similarities concerning the all pairs of characters. As the character similarity, a value (a Dice coefficient) obtained by dividing a frequency of a pair of characters by a frequency of two characters configuring the pair of characters is used. A self-interaction information amount or the like may be used as similarity.

In step 1425, concerning the similarities calculated in step 1424, the semantic relationship extraction device normalizes similarity concerning the same characters and similarity concerning different characters. Specifically, the semantic relationship extraction device calculates an average AS of the similarity concerning the same characters and an average AD of the similarity concerning the different characters, respectively. Concerning the same character, the semantic relationship extraction device sets 1.0 irrespective of calculated similarity. Concerning the same characters, the semantic relationship extraction device sets, as final similarity, a value obtained by multiplying the value calculated in step 1424 with AD/AS.

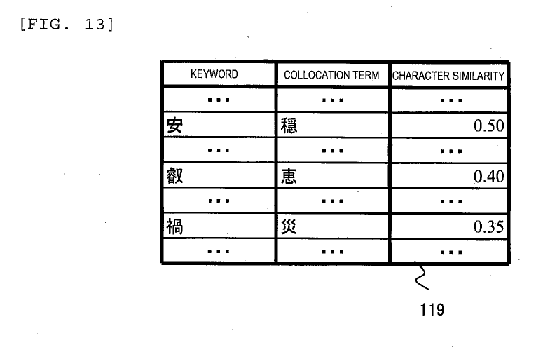

An example of a character similarity table is shown in FIG. 13. It is possible to calculate similar character overlapping degree using the character similarity table. The calculation of the similar character overlapping degree only has to be performed in the same manner as the calculation of the character overlapping degree. The calculation of the similar character overlapping degree is different from the calculation of the character overlapping degree in that, whereas, in the character overlapping degree, 1 as the number of characters is added when one character is a coinciding character, in the case of the similar character overlapping degree, the similar character table is referred to and, when a character is a similar character, character similarity is added. When a character is a coinciding character, since 1.0 is stored in the similar character table, the similar character overlapping degree is the same as the character overlapping degree.

Note that it is possible to use similarity obtained by a method of using similarity of morphemes (partial character string of a word) having similar meanings and a method of using an inclusion relationship of a word as disclosed in NPL 4.

In the following explanation, a method of configuring similarity necessary for extracting a detailed semantic relationship is explained. In the notation-based similarity, as in the case of the context-based similarity, it is possible to configure two kinds of similarities including similarity calculated with reference to one of a set of words and similarity calculated with reference to the other, that is, a set of asymmetrical similarities. For example, the method is considered with reference to a Jaccard coefficient as an example. The Jaccard coefficient is a coefficient for indicating similarity of two kinds of sets as a ratio of the number of elements of an intersection of two sets to the number of elements of a union of two sets. For example, when there are pairs of words like “ginkou in Chinese characters” and “toushiginkou in Chinese characters”, when the pairs of words are considered to be a set consisting of characters “gin in Chinese characters” and “kou in Chinese characters” and a set consisting of four characters “tou”, “shi”, “gin”, and “kou”, the number of elements of an intersection of two sets (coinciding characters) is 2, the number of elements of an union of two sets is 4, and the Jaccard coefficient is 0.5. The Jaccard coefficient is symmetrical. Here, it is considered to use, focusing on one word of a pair of words rather than the union of two sets, characters included in the word. Then, when focusing on “ginkou in Chinese characters”, a score is 2/2=1.0. When focusing on “toushiginkou in Chinese characters”, a score is 2/4=0 0.5. The scores are asymmetrical. This represents that “ginkou in Chinese characters” is a broader term of “toushiginkou in Chinese characters”. It is possible to accurately extract a detailed semantic relationship by configuring a set of asymmetrical feature values in this way and using both the feature values as feature values.

### (3) Pattern-Based Similarity

For pattern-based similarity, a pattern explicitly indicating a semantic relationship such as “B like A” or “C such as A and B” is used. By collating a pattern set in advance and a character string or a morphological analysis result, a pair of words matching the pattern is acquired. The number of extracted pairs of words is tabulated. Statistical processing such as normalization is performed to change the number of extracted pairs of words to a value of a dimension of a feature. A calculation method for the pattern-based similarity is disclosed in Non Patent Literature 3. Therefore, explanation of the calculation method is omitted.

In the following explanation, a configuration method for similarity necessary for extracting a detailed semantic relationship is explained. Two kinds of values including a value of a feature calculated with reference to one of a set of words and a value of a feature calculated with reference to the other are calculated. For example, concerning a pattern for extracting broader/narrower terms such as “B like A” or “B such as A”, the pattern itself has directionality. That is, when “B like A” is a natural expression, “A like B” is not used. In a similarity matrix, a pair of words <A, B> and <B, A> are not distinguished and are represented using broader/narrower terms and narrower/broader terms as labels. Therefore, as a feature value obtained from such a pattern indicating the broader/narrower terms, both of a feature indicating that “B like A” appears and a feature indicating that “A like B” appears are prepared. A parenthesis expression such as “customer relation management (CRM)” is an expression that often indicates synonyms and is effective. However, the parenthesis expression is not always used only as synonyms. For example, the parenthesis expression like “A company (Tokyo)” is sometimes used in the case of a noun and an attribute of the noun. Even in such a case, in the case of synonyms, expressions outside the parentheses and inside the parentheses can be interchanged. Therefore, it is possible to distinguish a case of synonyms and a case of an attribute by using both of a feature value indicating that “A (B)” appears and a feature value indicating that “B (A)” appears. Parallel expressions such as “A and (‘ya’) B” and “A and (‘to’) B” essentially do not have directionality. However, accurate processing cannot be performed if an analysis of the structure of a sentence cannot be correctly performed. For example, in an expression such as “A sha to keiyaku wo teiketu in Japanese (meaning ‘enter into an agreement with A company’)”, “‘to’” is not a postpositional particle indicating parallel. However, the expression is likely to be processed as a parallel marker by mistake. Even in such a case, by configuring a feature value taking into account whether an expression like “keiyaku to A sha in Japanese (meaning ‘ agreement and A company’)” is present, it is possible to extract only a pair-of words that is truly synonymous.

In this way, with the semantic relationship extraction device in the first embodiment of the present invention, by using a manually created additional information source such as a thesaurus as a correct answer and, at the same time, integrating similarities of different types such as a context base, an expression base, and a pattern base, it is possible to perform highly accurate semantic relationship extraction compared with the past. In particular, it is possible to determine more detailed classifications such as synonyms, broader/narrower terms, antonyms, and coordinate terms in similar terms. Since detailed distinction of the classifications is possible, extraction accuracy for each of the classifications is improved.

### Second Embodiment

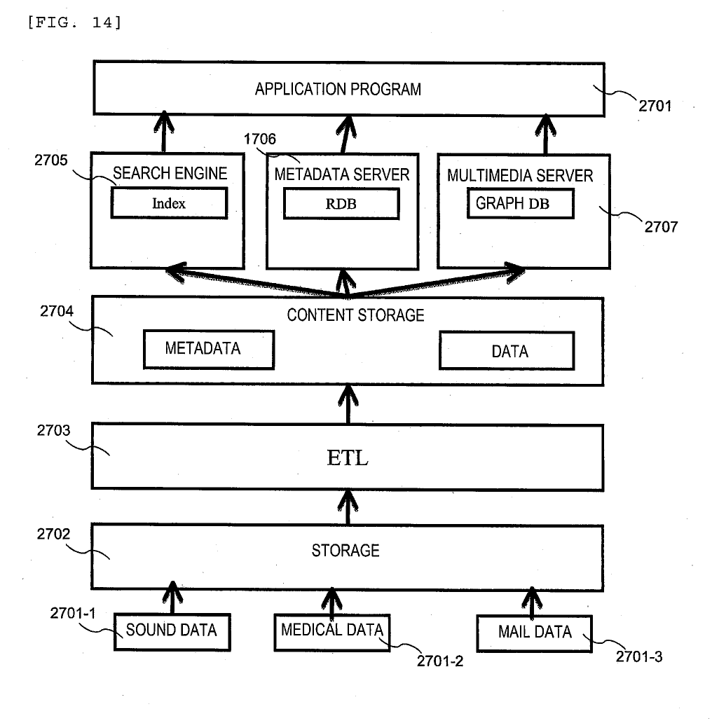

FIG. 14 is a schematic diagram of a content cloud system. The content cloud system is configured from an Extract Transform Load (ETL) 2703 module, a storage 2704, a search engine 2705 module, a metadata server 2706 module, and a multimedia server 2707 module. The content cloud system operates on a general computing machine including one or more CPUs, memories, and storage devices. The system itself is configured by various modules. The respective modules are sometimes executed by independent computing machines. In that case, storages and the modules are connected by a network or the like. The content cloud system is realized by distributed processing for performing data communication via the storages and the modules. An application program 2701 transmits a request to the content cloud system through a network or the like. The content cloud system transmits information corresponding to the request to the application 2701.

As inputs to the content cloud system, the content cloud system receives data of any forms such as sound data 2701-1, medical data 2701-2, and mail data 2701-3. The respective kinds of data are, for example, call center call sound, mail data, and document data and may be or may not be structured. Data input to the content cloud system is temporarily stored in various storages 2702.

The ETL 2703 in the content cloud system monitors the storage. When accumulation of the various data 2701 in the storage is completed, the ETL 2703 causes an information extraction processing module adjusted to the data to operate and stores extracted information (metadata) in the content storage 2704 in a form of an archive. The ETL 2703 is configured by, for example, an index module of a text or an image recognition module. Examples of the metadata include time, an N-gram index and an image recognition result (an object name), an image feature value and a related term of the image feature value, and a sound recognition result. In these information extraction modules, all programs for performing some information (metadata) extraction can be used and a publicly-known technique can be adopted. Therefore, here, explanation of the various information extraction modules is omitted. If necessary, data size of the metadata may be compressed by a data compression algorithm. After information is extracted by the various modules, processing for registering a file name of data, data registration year, month, and date, a kind of original data, metadata text information, and the like in a Relational Data Base (RDB) may be performed.

In the content storage 2704, the information extracted by the ETL 2703 and the data 2701 before processing temporarily stored in the storage 2702 are stored. When a request from the application program 2701 is received, for example, if the request is a text search, the search engine 2705 performs a search for a text on the basis of an index created by the ETL 2703 and transmits a search result to the application program 2701. Concerning a search engine and an algorithm of the search engine, a publicly-known technique can be applied. The search engine could include not only a text but also a module for searching for data such as an image and sound.

The metadata server 2706 performs management of metadata stored in the RDB. For example, if the file name of data, the data registration year, month, and date, the kind of original data, the metadata text information, and the like are registered in the RDB in the ETL 2702, when request from the application 2701 is received, the metadata server 2706 transmits information in the database to the application 2701 according to the request.

The multimedia serer 2707 associates information of the metadata extracted by the ETL 2703 each other, structures the information in a graph form, and stores meta information. As an example of association, original sound file and image data, related terms, and the like are represented in a network form with respect to a sound recognition result “ringo (Japanese equivalent of apple)” stored in the content storage 2704. When a request from the application 2701 is received, the multimedia server 2707 also transmits meta information corresponding to the request to the application 2701. For example, when a request “ringo” is received, the multimedia server 2707 provides related metal information such as an image and an average rate of an apple and a song title of an artist on the basis of a constructed graph structure.

In the content cloud system, a thesaurus is used as explained below.

First, a first pattern is a pattern for making use of the thesaurus in a search for metadata. When a sound recognition result is represented by metadata such as “ringo”, if a request “ringo in Chinese characters” is input, a search can be performed by converting a query into an synonym using the thesaurus. If given metadata is inconsistent and “ringo” is given to certain data and “ringo in Chinese characters” is given to another data, it is possible to treat the data assuming that the same metadata is given to the data.

Next, a second pattern is a pattern for making use of the thesaurus in giving metadata, in particular, in giving metadata using text information. For example, a task for giving metadata to an image using a text such as an HTML document including an image is considered. The metadata is obtained by subjecting words included in a text to statistical processing. However, it is known that accuracy is deteriorated by a problem called a sparseness that a data amount is insufficient and the statistical processing cannot be accurately performed. By using the thesaurus, it is possible to avoid such a problem and extract metadata at high accuracy.

The embodiments of the present invention are explained above. However, the present invention is not limited to the embodiments. Those skilled in the art would understand that the present invention can be variously modified and implemented and the embodiments explained above can be combined as appropriate.

### REFERENCE SIGNS LIST

100 Semantic relationship extraction device
101 CPU
102 Main memory
103 Input/output device
110 Disk device
111 OS
112 Semantic relationship extraction program
1121 Feature vector extraction subprogram
1122 Correct answer label setting subprogram
1123 Identification model learning subprogram
1124 Identification model application subprogram
113 Text
114 Thesaurus
115 Similarity matrix
116 Context matrix
117 Part-of-speech pattern
118 Identification model
119 Character similarity table

1. A semantic relationship extraction device comprising:
means for generating, respectively for a set of words extracted from a text, feature vectors including a different plurality of kinds of similarities as elements;
means for referring to a known dictionary and giving labels indicating semantic relationships to the feature vectors;
means for learning, on the basis of a plurality of the feature vectors to which the labels are given, as an identification problem of multiple categories, data for semantic relationship identification used for identifying a semantic relationship; and
means for identifying a semantic relationship for any set of words on the basis of the learned data for semantic relationship identification.

2. The semantic relationship extraction device according to claim 1, wherein the means for generating the feature vector includes:
means for extracting, as context information of a word of attention, a word in a vicinity of an appearance place in the text of the word of attention; and
means for calculating, as similarity of the set of words, similarity of context information of two words of the set of words, which is two kinds of similarities including similarity calculated with reference to one of the set of words and similarity calculated with reference to the other.

3. The semantic relationship extraction device according to claim 1, wherein the means for generating the feature vector includes:
means for calculating a correspondence relationship between characters included in two words of the set of words on the basis of whether the characters are same characters and meanings of the characters are similar; and
means for calculating, as similarity of the set of words, similarity based on the correspondence relationship between the characters, which is two kinds of similarities including similarity calculated with reference to one of the set of words and similarity calculated with reference to the other.

4. The semantic relationship extraction device according to claim 1, wherein
the means for generating the feature vector includes:
means for extracting a set of words according to a pattern stored in advance indicating a relationship between words; and
means for setting, as a value of a feature, a statistical amount based on a frequency of the extracted set of words, and
the means for generating the feature vector calculates two kinds including a value of a feature calculated with reference to one of the set of words and a value of a feature calculated with reference to the other.

5. The semantic relationship extraction device according to claim 1, wherein the semantic relationship indicates whether two words configuring the set of words are synonyms, broader/narrower terms, antonyms, or coordinate terms or are none of the synonyms, the broader/narrower terms, the antonyms, and the coordinate terms.

6. The semantic relationship extraction device according to claim 1, wherein further comprising means for determining that two words configuring the set of words are not synonyms when the two words are proper nouns and do not indicate a same thing.
